(19) United States
(12) Patent Application Publication
(10) Pub. No.: US 2025/0112992 A1
(43) Pub. Date: Apr. 3, 2025

(54) MACHINE LEARNING BASED SERVICE PERFORMANCE MANAGEMENT DIGITAL ASSISTANT

(71) Applicant: ADP, Inc., Roseland, NJ (US)

(72) Inventors: Keith Christoffers, Madison, NJ (US); John K. Mathew, Emerson, NJ (US); John F. Kneafsey, Newark, NJ (US)

(73) Assignee: ADP, Inc., Roseland, NJ (US)

(21) Appl. No.: 18/900,299

(22) Filed: Sep. 27, 2024

Related U.S. Application Data
(60) Provisional application No. 63/586,182, filed on Sep. 28, 2023.

(51) Int. Cl. H04M 3/51; G06F 16/332; G06F 40/205

(52) U.S. Cl. CPC H04M 3/5175; G06F 16/3329; G06F 40/205

(57) ABSTRACT

A machine learning (ML)-based service performance digital assistant is provided. The system can include a computing system with a processor and memory that can analyze an electronic transcript from audio samples of a client-service communication and detect a trigger phrase related to the performance event of an application using a first ML model. The system can generate, based on the trigger phrase, a search query using a second ML model trained on data corresponding to performance events. The system can select, based on the search query, an electronic resource via a search engine and send it to the provider device during the ongoing communication session between the client and the service device.

### CROSS-REFERENCES TO RELATED APPLICATIONS

This application claims the benefit of priority under 35 U.S.C. § 119 to U.S. Provisional Patent Application No. 63/586,182, filed Sep. 28, 2023, which is hereby incorporated by reference herein in its entirety.

### TECHNICAL FIELD

The present disclosure relates generally to computing technology, and particularly to machine learning (ML) based agent assistance, including, without limitation, systems and methods for an ML-based performance issue detection and resolution digital assistant.

### BACKGROUND

Clients can execute different applications on their devices to implement a variety of tasks. As client devices can vary in configurations and settings, whereas applications can vary in the types of data processed, it can be challenging to reliably, accurately, and efficiently identify and address different processing events that can be experienced by the clients without expending additional computing resources.

### SUMMARY

The technical solutions of this disclosure can provide real-time guidance to service provider agents by identifying client issues via real-time updated transcripts of ongoing user-service provider communications. The technical solutions can facilitate a data processing system that can utilize one or more large language models (LLMs) hosted on scalable cloud-based computing infrastructure and tailored for natural language processing (NLP) tasks, user-query generation, document retrieval and other tasks. The technical solutions can generate queries based on identified client issues to provide content recommendations, agent routing suggestions, guided workflows, and targeted automation solutions. For example, the technical solution can utilize the cloud infrastructure and the NLP models to transcribe an ongoing discussion (e.g., a customer service call) between a client and a service provider agent. The technical solutions can use the continuously updated transcript during the customer call to detect client-raised issues pertaining to the enterprise products or services. The technical solution can use the ML functionalities (e.g., the LLM or NLP models, semantic similarity search functions, document retrieval models, or query generation models) to efficiently and quickly select the relevant documents to address the client's issues.

In some aspects, the technical solutions described herein can relate to a system. The system can include a computing system comprising one or more processors coupled with memory. The computing system can parse an electronic transcript generated via a natural language processor from audio samples of a communication session established between a client device and a service device to identify at least a portion of the electronic transcript. The computing system can detect, prior to termination of the communication session and via input of the at least the portion of the electronic transcript into a first model trained with machine learning on historical log data, a trigger phrase that maps to a performance event concerning an application. The computing system can generate, responsive to input of the trigger phrase into a second model trained with a transformer-based neural network on data corresponding to performance events of the application, a search query configured for input into a search engine. The computing system can select, via the search engine, an electronic resource responsive to the search query generated via the second model. The computing system can transmit, for receipt by the provider device, prior to termination of the communication session with the client device, the electronic resource or an identification of the electronic resource. The provider device may render the received electronic resource in some examples.

In some aspects, the technical solutions described herein can relate to a method. The method can include parsing, by one or more processors coupled with memory, an electronic transcript generated via a natural language processor from audio samples of a communication session established between a client device and a service device to identify at least a portion of the electronic transcript. The method can include detecting, by the one or more processors, prior to termination of the communication session and via input of the at least the portion of the electronic transcript into a first model trained with machine learning on historical log data, a trigger phrase that maps to a performance event concerning an application. The method can include generating, by the one or more processors, responsive to input of the trigger phrase into a second model trained with a transformer-based neural network on data corresponding to performance events of the application, a search query configured for input into a search engine. The method can include selecting, by the one or more processors, via the search engine, an electronic resource responsive to the search query generated via the second model. The method can include rendering, by the one or more processors, by the provider device prior to termination of the communication session with the client device, the electronic resource.

In some aspects, the technical solutions described herein can relate to a non-transitory computer-readable medium storing instructions that, when executed by at least one processor, cause the at least one processor to parse an electronic transcript generated via a natural language processor from audio samples of a communication session established between a client device and a service device to identify at least a portion of the electronic transcript. The instruction, when executed by the at least one processor, can cause the at least one processor to detect, prior to termination of the communication session and via input of the at least the portion of the electronic transcript into a first model trained with machine learning on historical log data, a trigger phrase that maps to a performance event concerning an application. The instruction, when executed by the at least one processor, can cause the at least one processor to generate, responsive to input of the trigger phrase into a second model trained with a transformer-based neural network on data corresponding to performance events of the application, a search query configured for input into a search engine. The instruction, when executed by the at least one processor, can cause the at least one processor to select, via the search engine, an electronic resource responsive to the search query generated via the second model. The instruction, when executed by the at least one processor, can cause the at least one processor to transmit, for render by the provider device prior to termination of the communication session with the client device, the electronic resource.

### BRIEF DESCRIPTION OF THE DRAWINGS

Aspects of the present technical solutions are described in the detailed description which follows, in reference to the noted plurality of drawings by way of non-limiting examples of exemplary aspects of the present disclosure.

FIG. 1 is an illustrative example of a system for an ML-based service performance management digital assistant, in accordance with one or more aspects.

FIG. 2 illustrates a block diagram of an example computing system for implementing the aspects of the technical solutions.

FIG. 3 illustrates an example graph of a curve corresponding to a relationship between a call coverage and a number of support articles provided, in accordance with one or more aspects.

FIG. 4 illustrates an example graph of a time duration of a call with respect to content search, in accordance with one or more aspects.

FIG. 5 illustrates an example of a screenshots of a user interface of an application for providing or displaying content generated in accordance with one or more aspects.

FIG. 6 shows an example process flow of a method an ML-based service performance management digital assistant, in accordance with one or more aspects.

### DETAILED DESCRIPTION

The technical solutions of this disclosure can identify performance issues in a software application executed by one or more processors, such as in a server system. The technical solution can identify the performance issue by analyzing a communication session or channel, such as between a client device and a service device and facilitate addressing the performance issue. For example, the system can provide relevant technical documents to resolve such performance events based on a transcript of the ongoing service communication between the client and the service provider. When servicing client calls on enterprise products or services, identifying and addressing the performance issues described by the client can expend significant computing and telecommunications resources. As different clients can describe the same technical issues using different, and sometimes incorrect, phrases or descriptions, it can be technically challenging, and thus time and resource-intensive, to accurately identify the technical issues and the relevant technical contents for their resolutions. These variations in phrasing and description of the technical issues can impact both the telecommunication and the computational resources or even lead to failure in identifying the most relevant content to address the given processing issue event.

The technical solutions overcome these challenges by generating in real-time a transcript of an ongoing client communication and identifying via machine-learning the performance issue events described by the client and the corresponding technical documents to address the issues. The data processing system can harness extensive and detailed organizational information, such as articles, reports, and documents on products or services, to provide answers to the client inquires and provide the most relevant content addressing the issues. The technical solutions can further facilitate agent routing recommendations, guided workflows, and targeted automation solutions, such as ML-generated summary answers to the user inquiries based on ML-identified content materials addressing the client issues. By identifying the performance issues and providing the most relevant technical documentation for their resolutions, the technical solutions can improve the reliability and efficiency of the troubleshooting service while also conserving the telecommunication and the computational resources of the service provider.

For example, the technical solutions can utilize one or more machine learning (ML) large language models (LLMs) designed for natural language processing (NLP) tasks and provided via scalable cloud-based computing infrastructure. One or more NLP models can be used to transcribe (e.g., continuously transcribe, or in a batch mode based on a time interval or number of tokens or words) an ongoing communication (e.g., a customer service call) between a client and a service provider. Using the updated transcription of the call, the technical solutions can identify trigger phrases that can be used to detect issues or topics raised by the client during the communication. The data processing system can utilize ML models and functions (e.g., NLP or LLM models, semantic textual similarity search functions, document retrieval models, query generating models) to detect the performance issues raised by the client, generate queries for the issues raised and use the queries to identify documents discussing the identified performance event issues.

The technical solution can utilize various data sources for model development. For example, a data processing system can generate and use service provider's transcripts of client support and process them using one or more ML models. The technical solution can utilize a comprehensive and detailed information, including articles, reports, or documents created and managed within an organization (e.g., long-form enterprise content), as well as information collected about how extensively and effectively the long-form content is being accessed and employed within the organization, helping to gauge its relevance and impact on the knowledge management efforts.

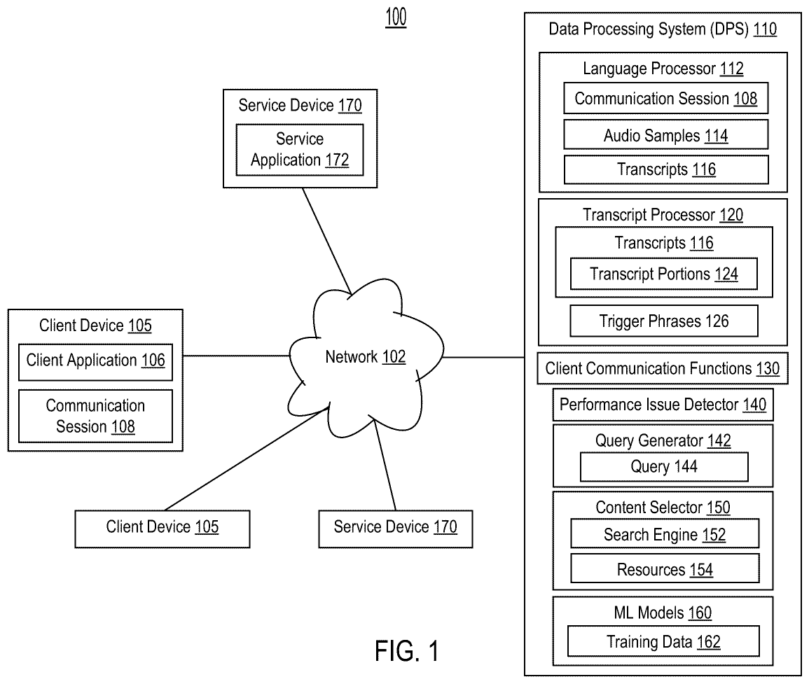

FIG. 1 is an illustrative example of a system for an ML-based service performance management digital assistant in accordance with one or more aspects. For example, system 100 can provide ML-based detection of application performance issues via a transcription of an ongoing client-provider communication and selection of the content material for the resolution of the performance issue. System 100 can include, interface with, utilize, communicate with, or otherwise access one or more client devices 105 executing one or more client applications 106 and communication sessions 108 for communicating with one or more service devices 170 executing one or more service applications 172 and one or more data processing systems (DSPs) 110 via one or more networks 102. System 100, such as a service device 170 servicing a communication from a client device 105 can include, utilize, interface with, or otherwise access a data processing system 110. The data processing system (DPS) 110 can include one or more language processors 112 for processing one or more communication sessions 108 and generating one or more transcripts 116 based on audio samples 114 of the communication sessions 108. The DPS 110 can include one or more transcript processors 120 for parsing and processing transcript portions 124 of the transcripts 116 to detect trigger phrases 126 for identifying performance issues. The data processing system 110 can include one or more client communication functions for implementing, maintaining, or managing the communication sessions 108 with the one or more client devices 105. The data processing system 110 can include one or more performance issue detectors 140 for identifying the performance issue events (e.g., by detecting trigger phrases 126 based on machine learning). The data processing system 110 can include one or more query generators 142 for generating search queries based on the trigger phrases to identify technical documents relevant to the performance issue event identified in the transcript portions 124. The data processing system 110 can include a content selector 150 implementing one or more search engines 152 to generate one or more relevant electronic resources 154 to provide to the client device via one or more client communication functions 130. The DPS 110 can include one or more ML models 160 equipped with various types of artificial intelligence (AI) or ML functionalities and trained using various types of training data 162 to implement the functionalities of the language processor 112, the transcript processor 120, the performance issue detector 140, the query generator 142 and the content selector 150.

For example, a client device 105 (e.g., a personal computer, a tablet, or a smartphone) can execute a client application 106, such as an application that can implement communication session 108 with service device 170 (e.g., a service provider device for a call center handling communication sessions 180). The service device 170 can utilize the service application 172 to handle, service or otherwise process the communication session 108 from the client device 105 using various functionalities or features of the data processing system 110. The client application 106 and the communication session 108 can be provided via any network session or a connection, such as a TCP/IP connection, a phone call function, or a voice over IP (VOIP) function. The client application 106 can establish a communication session 108 comprising a voice call, such as a phone call, a VOIP session, an audio-video conference, or a chat communication with the service device 170 which can be coupled with, in communication with or comprised by or can comprise a DPS 110 of an enterprise (e.g., a service provider).

Service device 170, also referred to as a service provider device, can include any combination of hardware and software for receiving, processing or handling communication sessions 108 from client devices 105. Service device 170 can include one or more physical or virtual servers or machines or a cloud-based platform. Service device 170 can include or comprise a data processing system 110 or can be comprised by, or within, a data processing system 110. Service device 170 can be associated with or process communication sessions 108 for one or more enterprises (e.g., corporations or organizations) via one or more service applications 172.

Service application 172 can include any combination of hardware and software for communicating with a client application 106 or a data processing system 110. Service application 172 can establish, parse, handle or process communications or transmissions communicated via the communication session 108. Service application 172 can be any application for providing communication between agents providing services of an enterprise and clients, such as a chatbot application, a voice over IP (VOIP) application for receiving client calls, a video conferencing application or a telephonic call application or service. Service application 172 can be configured to access, handle or utilize any one or more of the data processing system 110 functions. For instance, service application 172 can utilize application programming interface (API) calls to any one or more of language processor 112, transcript processor 120, client communication functions 130, performance issue detector 140, content selector 150 or ML models 160 to implement their respective functionalities.

Network 102 can include any connection or a communication link between a client device 105 and a data processing system 110, allowing for establishing a communication session 108. Network 102 can be configured to exchange network traffic, such as video or audio streams, or any other transmissions (e.g., via one or more communication sessions 108). Network 102 can include wired or wireless connections, supporting a wide range of connections, including, for example, Ethernet, Wi-Fi, or cellular networks (e.g., 4G, 5G). For instance, network 102 can include wired connections, including Ethernet cables transmitting data over a local area network (LAN) and wireless connections using Wi-Fi or mobile networks for real-time communication, media streaming, or data transfer between the client device 105 and the data processing system 110.

Data processing system 110 can include any combination of hardware and software to provide ML-based digital assistance for resolving performance issues raised by the clients in communication sessions 108. The data processing system 110 can include one or more processors (e.g., 210) that can be coupled with memory (e.g., 215) that can include and store computer commands, instructions, or data for implementing various functionalities of the data processing system 110 discussed herein. Data processing system 110 can be implemented on one or more server devices (e.g., a server or a server farm), one or more virtual machines, or a cloud computing system. Data processing system 110 can include servers or virtual machines including storage devices (e.g., 225) that can include various features of the data processing system, including training data 162 and resources 154. Data processing system 110 can include or implement language processors 112, transcript processors 120, client communication functions 130, performance issue detectors 140, query generators 142, content selectors 150, and ML models 160.

The DPS 110 can use a language processor 112 to transcribe in real-time (e.g., from audio samples 114 of the communication session 108) the words and phrases stated during the communication session 108 between the client (e.g., a user at the client device 105) and an agent of the enterprise service provider operating via a the service application 172 of the service device 170. The language processor 112 can include any combination of hardware and software for generating a transcript 116 based on portions of the communication session 108, such as audio samples 114 of a voice call between the client and the service provider's agent. The language processor 112 can periodically, regularly, or continuously update the transcript 116 with new transcript portions 124 based on the incoming or new audio samples 114 of the ongoing communication session 108. The continuously updated transcript 116 can be comprised of a plurality of transcript portions 124 (e.g., sections of the transcript), reflecting the ongoing communication (e.g., conversation) between the client and the agent of the service provider (e.g., service device 170).

The audio samples 114 can be captured by a sensor of the client device 105, such as a microphone. The sensor or microphone can be integrated as part of the client device 105, or a microphone that is connected, either wirelessly or with a wire, to the client device 105. The client device 105 can capture the audio or acoustic input via the sensor to generate audio samples 114. The audio samples 114 can be generated using any audio technique or function. For example, the client device 114 can digitize the audio to generate audio samples 114 at a sample rate and then transmit the audio samples 114 to the data processing system 110 via network 102. By digitizing the audio samples, the system 100 can reduce network bandwidth communications. In some cases, the audio can be transmitted to the data processing system 110 via a telephone or cellphone network. In some cases, the audio samples can be transmitted using Voice-over-IP technology.

Client communication functions 130 can include any combination of hardware and software for establishing, maintaining, providing and implementing communication between the data processing system 110 and the one or more client devices 105. A client communication function 130 can be implemented on a server device 170 that is configured to include, be coupled with, or otherwise provide the data processing system 110 and used for providing service by the agents of the enterprise. Client communication function 130 can receive an audio stream (e.g., audio samples 114) of a voice call from the client device 105 and can provide a voice call (e.g., audio samples 114 of the agent responses) back to the client device 105. Client communication function 130 can include one or more user interfaces, such as a graphical user interface (GUI) for providing outputs to the client device 105 or the client application 106. The GUI of the client communication function 130 can provide one or more windows or graphical outputs, including a summary of the detected performance issue (e.g., performance issue event) detected by the performance issue detector 140 and one or more electronic resources 154 (e.g., digital versions of documents addressing the technical challenge encountered by the client during the performance event).

Transcript processor 120 can include any combination of hardware and software for parsing and processing portions of the transcripts 116 (e.g., transcript portions 124) to identify or detect trigger phrases 126. The transcript portions 124 can include any sections of the transcript 116, such as one or more paragraphs, one or more sentences, one or more phrases, or one or more words of the transcript 116. Transcript portions 124 (e.g., a paragraph or one or more sentences) can be inserted into one or more ML models 160 trained on a corpus of technical documents (e.g., training data 162 having various resources 154 describing various technical issues and their respective solutions). The one or more ML models 160 can be trained to detect, using the transcript portions 124 input into ML models 160, trigger phrases 126 that can be indicative of particular performance issues or events, such as particular technical malfunctions or errors that can be described in the corpus documentation of resources 154 or training data 162 used to train the one or more ML models 160.

Trigger phrase 126 can include any one or more words or phrases indicative of a performance issue event described by the client during a communication session 108. Trigger phrase 126 can include a phrase stated by a client during a service call (e.g., communication session) transcribed by the language processor 112 into a transcript 116. The phrase can include, for example, a user's choice of words and description of the technical issues, challenges, or complications encountered by the user during the course of using a client application 106 (or any other product or service). The trigger phrase 126 can include one or more phrases or statements that are different than the actual phrase stated by the client in the transcript 116 but include the same or similar meaning as the stated phrase within the context of the transcript 116. For instance, a transcript processor 120 can utilize an ML model 160 to identify a plurality of trigger phrases 126 based on one or more phrases from a transcript portion 124, based on the overall context or description of the problem from the transcript 116. The ML model 160 can utilize semantic similarity functions to identify one or more phrases having a similar meaning (e.g., within a particular threshold range of a cosine similarity function or a Euclidean distance function) as the original phrase stated by the client. In some instances, the original phrase can be identified as the only trigger phrase 126 for the transcript 116. In some examples, a transcript processor 120 can generate a trigger phrase 126 in addition to the phrase stated by the client while describing the technical issue or problem encountered during the audio sample 114 as transcribed. In such instances, the data processing system 110 can utilize two trigger phrases 126, including the original phrase stated by the client and the trigger phrase 126 generated by the ML model 160 based on the similarity search (e.g., semantic similarity function determined to be within a predetermined similarity search threshold within the vector space of the training data set).

Performance issue detector 140 can include any combination of hardware and software for detecting performance issues based on transcripts 116 of the communication session 108 with a client device 105. Performance issue detector 140 can determine performance issues, including any technical errors or malfunctions pertaining to services or products (e.g., client application 106) provided by a service provider. The performance issue detector 140 can include the functionality to analyze transcript portions 124 of the transcript 116 to identify the statements of the client (e.g., user descriptions) of the issues or problems encountered in order to determine the performance issue or performance issue event. For instance, the performance issue detector 140 can utilize trigger phrases 126 associated with particular technical issues or errors to identify the performance issue described by the client.

Performance issue detector can determine the performance issues by using one or more ML models 160, which can be trained using training data 162. The training data 162 can include any corpus of documentation on any range of issues, topics, tasks or concerns faced or encountered by any number of clients. The ML models 160 can be trained by the training data 162 to detect, identify, recognize, determine, or generate the issue or topic being raised or discussed by the client. For example, a model 160 can utilize training data 162 to determine, from a transcript 116, one or more trigger phrases 126 associated with one or more particular technical issues. Based on the trigger phrases 126, the ML models 160 can determine that the client is asking a question concerning a particular product (e.g., application function or a feature), a particular service, a technical issue, a billing question, or any other question or issue regarding a problem or a technical, product or service related challenge that the client may be experiencing and expressing via the communication session 108 (e.g., and its corresponding transcript 116).

Query generator 142 can include any combination of hardware and software for generating queries 144 for input into a search engine 152 to identify electronic resources 154 (e.g., documents on the specific performance issue discussed by the client). The query generator 142 can utilize a model 160 trained using training data 162, which can include data or information, such as product or user manuals, data sheets, product literature, or other information corresponding to a particular field. The field can be any field or range of topics, such as a particular product or service type (e.g., electronic products, services, or devices), software products or services, software applications, data products or services, human resource or payroll products or services, payment processing applications or functions, database functionalities, articles of manufacture, such as clothing, products or tools, construction services or products, medical services or products, or any other product or service fields. ML model 160 can use the field-related data as well as any trigger phrases 126 to determine or generate a query 144 for the particular field (e.g., service, product, event).

Query 144 can include a collection or string of characters corresponding to, indicative of, or describing an issue the client is discussing in the transcript 116. The query 144 generated by the query generator 142 can include information or data corresponding to the technical issue and indicative of particular subset of resources 154 corresponding to the performance issue event discussed by the client. The query 144 can be indicative of the field and technical issues corresponding to the trigger phase 126, which can be associated with a particular one or more document resources 154 in the dataset stored in a database of a storage device. Query 144 can be generated based on, or using, one or more trigger phrases 126, such as a particular description phrase or a word indicative of a technical issue corresponding to the performance event discussed in the transcript 116.

Content selector 150 can include any combination of hardware and software for selecting content documents (e.g., resources 154) to address the performance issue events. Content selector 150 can include the functionality to apply queries 144 into one or more search engines 152 to identify one or more of the most suitable resources 154 to address the performance issue corresponding to the trigger phrases 126. Content selector 150 can utilize a model 160 trained using training data 162, which can include data or information, such as user or product manuals, procedures, and technical or other data, to identify, select, or determine one or more documents relevant to the query or the issue the user is asking about. For example, the content selector 150 can utilize a model 160 to identify the literature most relevant to the client's query. For example, the content selector 150 can analyze the one or more selected documents to identify and generate the response or answer to the query, such as in the form of a paragraph, or a description.

Content selector 150 can utilize one or more search engines 152 to identify the resources 154 addressing the performance events raised by the client during the transcript 116. A search engine 152 can include any specialized tool designed or configured to identify relevant documents (e.g., resources 154) or their portions (e.g., paragraphs or sentences of such resources 154) based on query 144. The search engine 152 can include the functionality to analyze the transcript 116 and dynamically generate a query 144 that captures the client's performance issue. The search engine 152 can include the functionality implementing the natural language processing (NLP) techniques to match the query 144 to the relevant documents (e.g., resources 154). The search engine 152 can utilize machine learning to match the resources 154 to the queries 144 even if the language used differs from that in the technical materials. The content selector 150 can include the functionality to index the technical corpus at a granular level, such as by section, paragraph, or instruction, allowing the search engine 152 to retrieve the most specific and relevant parts of the documents. The search engine 152 can use context expansion techniques, leveraging domain-specific language, synonyms, and related terms to ensure accurate and comprehensive results, to allow the content selector 150 to provide the most relevant resources 154 and their most relevant sections (e.g., pages or paragraphs).

ML models 160 can include any combination of AI or ML models, such as semantic search models and question-answering models, which can be used to transcribe, summarize or describe an ongoing communication, identify trigger phrases 126, generate queries 144 and support an intelligent search engine to identify resources 154 to address technical issues. ML models 160 can utilize semantic search models, like BERT or GPT-based models, to allow the system to understand the meaning behind the client's trigger phrases 126 or queries 144 by encoding contextual relationships between words. ML models 160 can use contextual embeddings to match the query with relevant sections of technical documents, even if the client's language differs from the document language. For instance, trigger phrases 126 identified in the transcript 116 can be associated with other phrases not specifically stated in the transcription 116 but having similar or the same meaning within the given context of the conversation. By using context similarity searches in the training data 162 (e.g., comprising corpora of technical documents addressing various issues) the ML models 160 can identify multiple trigger phrases 126 associated with one or more phrases stated in the transcript 116.

ML models 160 can include question-answering models that can assist by isolating specific paragraphs, sections, or instructions that address the performance issue raised, improving the relevance of search results. ML models 160 can include techniques, such as named entity recognition (NER) and topic modeling, to help detect specific terms or topics related to the client's concerns, allowing for a more targeted search.

ML models 160 can include generative Artificial Intelligence (GAI) models that can be used to generate or identify trigger phrases 126 based on one or more statements stated by the client from the transcript 116. GAI models can be designed to generate content or new content, such as text, images, or code, by learning patterns and structures from existing data. GAI models can include a computational system or an algorithm that can learn patterns from data (e.g., chunks of data from various input documents, computer code, templates, forms, etc.) and make predictions or perform tasks without being explicitly programmed to perform such tasks. GAI models can refer to or include a large language model (LLM), which can be trained using a dataset of documents (e.g., text, images, videos, audio, or other data). GAI model can be designed to understand and extract relevant information from the dataset and leverage NLP techniques and pattern recognition to comprehend the context and intent of phrases from the transcript 116 and identify one or more trigger phrases 126 having the same or a similar meaning as the original phrase, given the context of the transcript 116.

ML models 160 can be built using deep learning techniques, such as neural networks, and can be trained on large amounts of data. ML models 160 can be designed, constructed or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network applied independently to each position. The data processing system 110 can apply layer normalization to the output of the attention and feed-forward sub-layers to stabilize and improve the speed with which the ML models 160 is trained. The data processing system 110 can leverage any residual connections to facilitate preserving gradients during backpropagation, thereby aiding in the training of the deep networks. Transformer architecture can include, for example, a generative pre-trained transformer, a bidirectional encoder representation from transformers, transformer-XL (e.g., using recurrence to capture longer-term dependencies beyond a fixed-length context window), text-to-text transfer transformer,

ML models 160 can be trained (e.g., by a model training function) using any text-based dataset by converting the text data from the input dataset documents into numerical representations (e.g., embeddings) of the chunks of those documents. These embeddings can capture the semantic meaning of words, paragraphs, pages or sentences, depending on the size and type of chunks of dataset documents are parsed into. Embeddings can be used to represent and organize the dataset documents within a high-dimensional space (e.g., embedding space), where similar documents or concepts are located closer together. Embedding space can include a multi-dimensional vector space where each data point is represented by an embedding.

Through training, the ML models 160 can learn or adjust its understanding of mapping the embeddings to particular issues (e.g., particular types of template outputs, particular form-related functionalities, placeholder and variable relations, and more) by adjusting its internal parameters. Internal parameters can include numerical values of the ML models 160 that the model learns and adjusts during training to optimize its performance and make more accurate predictions. Such training can include iteratively presenting the various data chunks or documents of the dataset (or their chunks, embeddings) to the ML models 160, comparing its predictions with the known correct answers, and updating the model's parameters to minimize the prediction errors. By learning from the embeddings of the dataset data chunks, the ML models 160 can gain the ability to generalize its knowledge and make accurate predictions or provide relevant insights based on the transcript portions 124, trigger phrases 126, or queries 144.

System 100 can include a DPS 110, including at least one processor 210 coupled with memory 215 to implement the functionalities of the data processing system 110, including any functionalities or features of the language processor 112, transcript processor 120, client communication function 130, performance issue detector 140, query generator 142, content selector 150, search engine 152 and ML models 160. The at least one processor 210 can utilize instructions and data from the memory 215 to operate a client communications function 130 to establish, maintain, and implement the communication session 108 between the client device 105 and the data processing system 110. The at least one processor 210 can utilize instructions and data from the memory 215 to implement a language processor 112 to utilize audio samples 114 (e.g., sampled periodically, such as every 0.1, 1, 2, 5, 10 or 15 seconds or 30 seconds) to generate transcript portions 124 of a transcript 116.

The at least one processor 210 can utilize instructions and data from the memory 215 to identify a transcript 116 that is updated according to the ongoing communication session 108 and includes most updated transcript portions 124. The at least one processor 210 can utilize instructions and data from the memory 215 to utilize the one or more ML models 160 to identify, detector, or generate one or more trigger phrases 126 based on the text or phrases from the transcript 116 (e.g., one or more transcript portions 124). For instance, the processor 210 can be configured (e.g., via commands or data stored in the memory 215) to implement a transcript processor 120 to input one or more transcript portion 124 into the ML model 160 trained using training data 162 (e.g., on a plurality of documents on performance issue events and their solutions) to identify one or more trigger phrases 126. A trigger phrase 126 can include a phrase stated or described by a client or an agent during a transcript 116. The trigger phrase 126 can include a phrase identified based on a semantic similarity search between the embedding of the statement made in the transcript 116 and an embedding or a vector of a statement provided in the technical documentation of the training data 162 describing a technical issue. A similarity search, such as a Euclidean distance or a cosine similarity, can be performed between the embeddings of the transcript 116 or the one or more transcript portions 124 (e.g., phrases or statements) to identify the trigger phrases 126. Such trigger phrases 126 can be indicative of or corresponding to the particular performance issues described by one or more resources 154 that can be included in the one or more training data 162 used to train the ML model 160.

For instance, an ML model can detect one or more portions of a technical disclosure or a text (e.g., resource 154) based at least on a portion of the transcript 116 (e.g., transcript portion 124) that can correspond to a completed portion of the ongoing call input into a first model 160 that can be trained using historical log data. The historical log data can include data comprising a plurality of trigger phrases corresponding to issues (e.g., performance events or performance issues) of an application. The first model 160 can detect, responsive to the portion of the transcript input, a trigger phrase 126 corresponding to a particular performance event (e.g., a technical issue involving a service or a product), such as an issue corresponding to the client application 106, or a service provided by the service provider and used by the client. The trigger phrase 126 can include one or more words stated by the client or the agent over the communication session 108 while describing the performance event (e.g., the issue corresponding to the performance failure) discussed by the client.

DPS 110 can generate a query 144, based on the trigger phrases 126, to use as input into search engine 152 to identify resources 154 corresponding to the performance issue. DPS 110 can generate the query 144 responsive to the detection and based at least on a description or an indication of the issue identified in at least a transcript portion 124 of a plurality of transcript portions 124 of the transcript 116. Transcript processor 120 can utilize the ML model 160 to generate, based on semantic or similarity search of the embedding of the description or the indication of the issue from the transcript 116 with the vector space of the relevant technical documentations of the training data 162, one or more trigger phrases 126 corresponding to the performance issue of the transcript 116. The one or more trigger phrases 126 can be input into a second ML model 160 that is trained using training data 162 corresponding to performance events of the application to generate a query 144. The query 144 can be used by the content selector 150 (e.g., via one or more ML models 160) as an input into the search engine 152 to select one or more documents that correspond to the query 144 (e.g., the issue raised by the client). The search engine 152 can include a third ML model 160 trained using data (e.g., 162) comprising a plurality of documents corresponding to performance events or issues of the application. The third ML model 160 can identify one or more sections of the relevant resources 154 and can rank the resources based on their similarity or relevance (e.g., cosine similarity or Euclidean distance) or similarity determinations to determine their ranking. For instance, the DPS 110 can provide the one or more documents (e.g., resources 154) for display to the display of the provider (e.g., via a user interface of the service provider agent's application).

DPS 110 can generate a ranking for each of the one or more documents according to a similarity search between the query 144 and each of the one or more documents (e.g., resources 154). DPS 110 can provide for display (e.g., via a user interface of a client communication function 130) the one or more documents (e.g., resources 154) identified based on the query 144 and the search engine 152. The documents (e.g., resources 154) can be ordered according to the ranking (e.g., based on their relevance or similarity search score with respect to the query 144). The documents can be provided for display during the ongoing call (e.g., during the communication session 108) between the client and the agent of the service provider. The one or more documents (e.g., resources 154) can be provided for display and can be ordered according to the ranking. The query 144 can correspond to a performance issue or an event raised by the client within a portion of the transcript 116. The performance issue or event can correspond to a performance issue of an application of the provider, such as a client application 106, or any application executed on a server of a service provider (e.g., data processing system 110) and provided to the client device 105 via a network 102, including any software as a service (SaaS), a software as a platform (SaaP), or any other service or a product that a client can utilize.

DPS 110 can commence, responsive to the start of the ongoing call, creation of the transcript 116 and can update, during the ongoing communication session 108 between the client device and the agent of the service provider, the portion of the transcript 116 to be input into the first ML model 160. DPS 110 can detect, based at least on the portion of the transcript, the performance event (e.g., the issue with the application) discussed by the client during the ongoing call.

DPS 110 can identify a second portion of the transcript 116 corresponding to a second completed portion of the ongoing call that is subsequent to the first portion of the ongoing call used to detect the performance event. DPS 110 can detect, based on the second portion of the transcript 116 input into the first model 160, a description of a second performance event (e.g., a second technical issue different than the first issue) discussed by the client during the call. Based on the description of the second performance event, the transcript processor 120 can generate one or more second trigger phrases 126 for the second performance event (e.g., second performance issue). Query generator 142 can generate a second query 144 based on the one or more second trigger phrases 126. DPS 110 can select, based at least on a second query 144 (e.g., corresponding to the second performance event) input into the third ML model 160, a second one or more documents (e.g., resources 154) corresponding to, or addressing, the second performance event (e.g., the second issue).

DPS 110 can determine that the second performance event is different than the first performance event. DPS 110 can select the second one or more documents (e.g., a second one or more resources 154) corresponding to the second performance event (e.g., a second technical issue), responsive to the determination that the second performance event is for a different issue than the first performance event. DPS 110 can generate or provide, based on the one or more documents (e.g., 154) input into a large language model 160, one or more summaries of the performance event (e.g., the issue with the application or service that the client can use). The summary of the performance event can include information about the performance event (e.g., performance issue) based on the one or more documents (e.g., resources 154). The one or more summaries can include information instructing the client to address or overcome the technical challenges caused by the performance event. The one or more summaries can list or provide one or more actions to take corrective action to correct or address the performance issue identified by the transcript 116. DPS 110 can provide the one or more summaries for display (e.g., via one or more user interfaces of the client communication functions), responsive to the generation or determination of the one or more summaries.

DPS 110 can generate, for the one or more documents (e.g., electronic resources 154), one or more scores. Each score can be generated according to a relation between each document (e.g., 154) of the one or more documents and the performance event (e.g., query 144 corresponding to the trigger phrases 126). DPS 110 can provide, based at least on the one or more scores, a recommendation for the client device 105 for a document of the one or more documents. DPS 110 can detect that the call has ended and generate, based at least on the transcript, a summary of the transcript identifying the performance event (e.g., the issue with the application or service used by the client). DPS 110 can determine, based on the detected performance event (e.g., the issue), to route the ongoing call to an agent of the service provider to address the client question pertaining to the performance event. DPS 110 can trigger, based at least on the determination of the agent, the routing of the ongoing call to the agent identified based on the performance event. Routing the call can refer to or include transmitting, forwarding, or relaying the call or communication session from one device to another device.

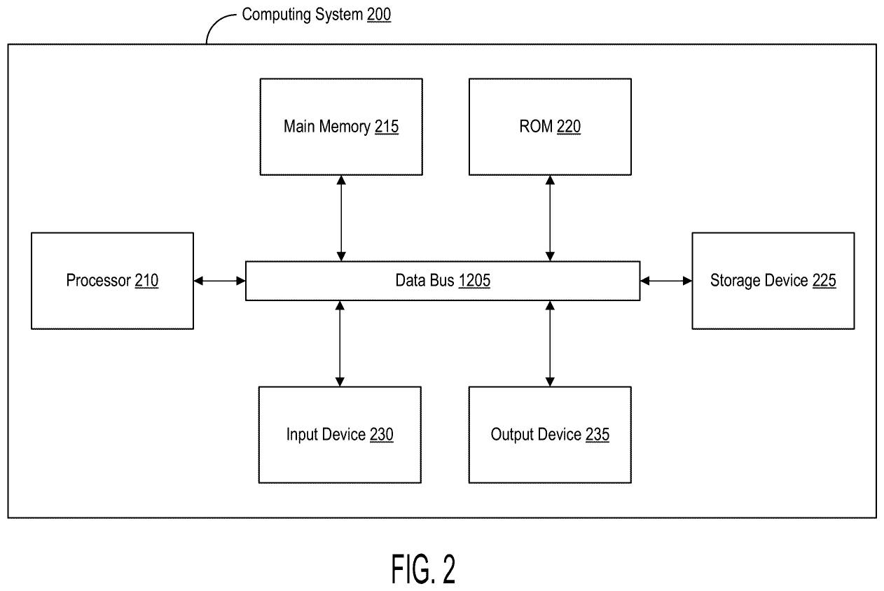

FIG. 2 illustrates a block diagram of a computing system 200 for implementing the embodiments of the technical solutions, in accordance with an aspect. The block diagram of the example computing system 200 can also be referred to as the computer system 200 or a computing environment 200. Computing system 200 can be used to implement elements of the systems and methods described and illustrated herein, such as for example, commands, instructions or data described herein. Computing system 200 can be included in and run any device (e.g., a data processing system).

Computing system 200 can include at least one bus data bus 205 or other communication device, structure or component for communicating information or data. Computing system 200 can include at least one processor 210 or processing circuit coupled to the data bus 205 for executing instructions or processing data or information. Computing system 200 can include one or more processors 210 or processing circuits coupled to the data bus 205 for exchanging or processing data or information along with other computing systems 200. Computing system 200 can include one or more main memories 215, such as a random access memory (RAM), dynamic RAM (DRAM), cache memory, or other dynamic storage device, which can be coupled to the data bus 205 for storing information, data and instructions to be executed by the processor(s) 210. Main memory 215 can be used for storing information (e.g., data, computer code, commands, or instructions) during the execution of instructions by the processor(s) 210.

Computing system 200 can include one or more read only memories (ROMs) 220 or other static storage device 225 coupled to the bus 205 for storing static information and instructions for the processor(s) 210. Storage devices 225 can include any storage device, such as a solid state device, magnetic disk, or optical disk, which can be coupled to the data bus 205 to persistently store information and instructions.

Computing system 200 may be coupled via the data bus 205 to one or more output devices 235, such as speakers or displays (e.g., liquid crystal display or active matrix display) for displaying or providing information to a user. Input devices 230, such as keyboards, touch screens, or voice interfaces, can be coupled to the data bus 205 for communicating information and commands to the processor(s) 210. Input device 230 can include, for example, a touch screen display (e.g., output device 235). Input device 230 can include a cursor control, such as a mouse, a trackball, or cursor direction keys, for communicating direction information and command selections to the processor(s) 210 for controlling cursor movement on a display.

The processes, systems and methods described herein can be implemented by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors 210 in a multi-processing arrangement may also be employed to execute the instructions contained in main memory 215. Hard-wired circuitry can be used in place of or in combination with software instructions together with the systems and methods described herein. Systems and methods described herein are not limited to any specific combination of hardware circuitry and software.

Although an example computing system has been described in FIG. 2, the subject matter including the operations described in this specification can be implemented in other types of digital electronic circuitry, or in computer software, firmware, or hardware, including the structures disclosed in this specification and their structural equivalents, or in combinations of one or more of them.

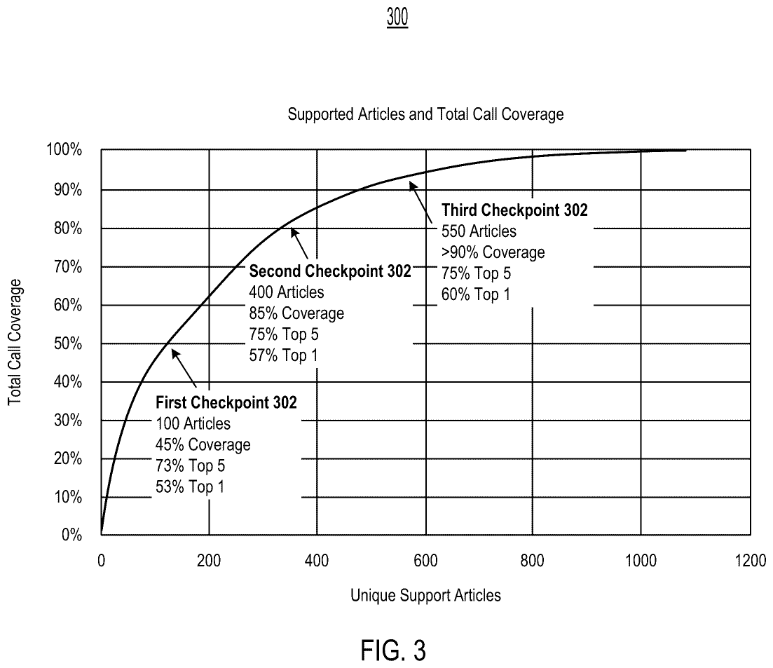

FIG. 3 illustrates an example graph of a curve or a plot 300 illustrating a relationship between a call coverage and the number of support articles provided, in accordance with an embodiment of the technical solutions. Curve 300 can illustrate the data for different checkpoints 302. For example, a first checkpoint 302 (e.g., in November of the first year) can reflect 100 articles being provided at about a 45% coverage of the calls. The first checkpoint 302 can correspond to data that includes the top 5 ranked documents (e.g., electronic resources 154) provided by the technical solution being accurate 73% of the time (e.g., resolving the client's issue 73% of the time), while the top 1 ranked document addressed the issue 53% of the time. For example, a second checkpoint 302 (e.g., in February of a second year, following the first year) can reflect 400 articles being provided at about an 85% coverage of the calls. In second checkpoint 302, the top 5 ranked documents (e.g., electronic resources 154) provided by the technical solution can address the issue 73% of the time (e.g., resolving the client's issue 73% of the time), while the top 1 ranked document addressed the issue 57% of the time. For example, a third checkpoint 302 (e.g., in May of the second year) can reflect 550 articles being provided at over 90% coverage of the calls. In third checkpoint data, the top 5 ranked documents (e.g., electronic resources 154) provided by the technical solution can address the issue 75% of the time (e.g., resolving the client's issue 75% of the time), while the top 1 ranked document addressed the issue 60% of the time.

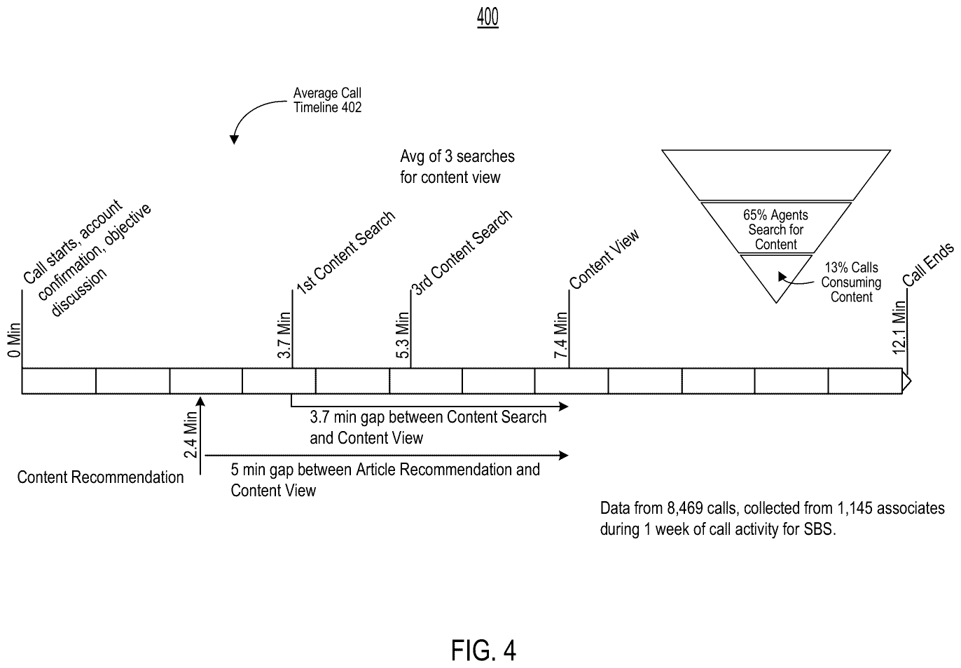

FIG. 4 illustrates an example graph 400 of an average call timeline 402 showing the time duration of a call with respect to content search. In graph 400, an average call timeline 402 can start at minute 0 and can have its first content search at about 3.7 minutes, a third content search at about 5.3 minutes, and a content view at about 7.4 minutes from the start of the call. As a result, there can be about 5-minute gap between article recommendation and the content view in an average call. The technical solution can reduce this issue by expediting and minimizing the time it takes to identify the issues on an ongoing basis, expediting the time it takes to identify the client issues and identify the relevant content, thereby saving time, computational and communication resources, and improving client service. For instance, instead of performing multiple content searches, which can lead to an average of 12.1-minute call duration, the technical solutions could, with successful content searches at the first attempt, bring such calls to an end shortly after 3.7 minutes (e.g., after the first content search).

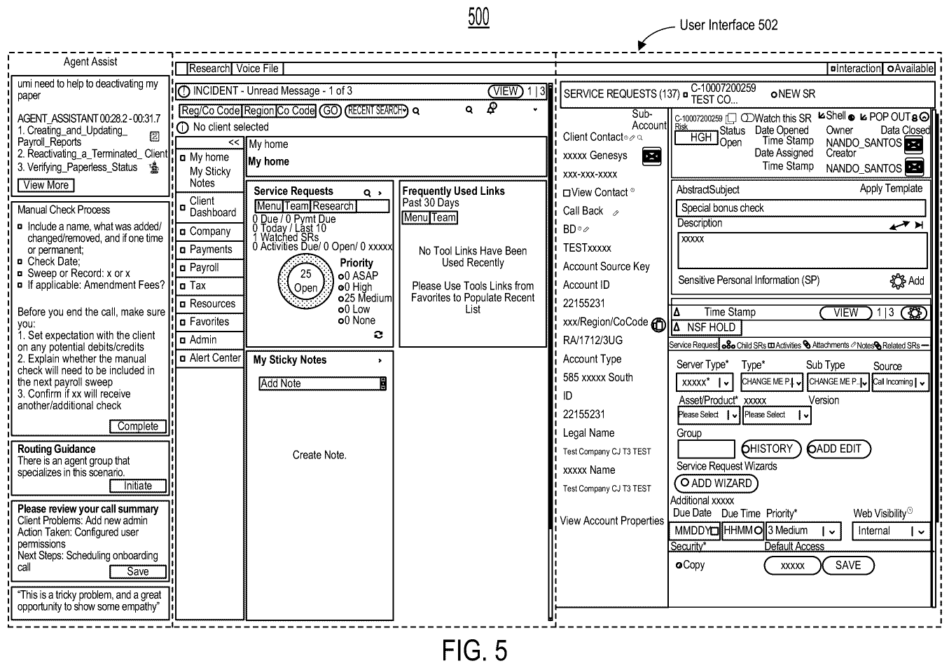

FIG. 5 illustrates an example 500 screenshot of a user interface 502 of an application for providing or displaying content generated in accordance with an embodiment. The user interface 502 can be provided by the DPS 110 to the agent at the enterprise receiving the client call. The user interface 502 can be displayed on a client device and can be provided for an agent assist application, providing various data to the agent, such as routing guidance, review call summary, suggesting responses to the client, identifying and providing service requests or issues, providing any historical client data (e.g., prior service calls), or any other data or information discussed herein.

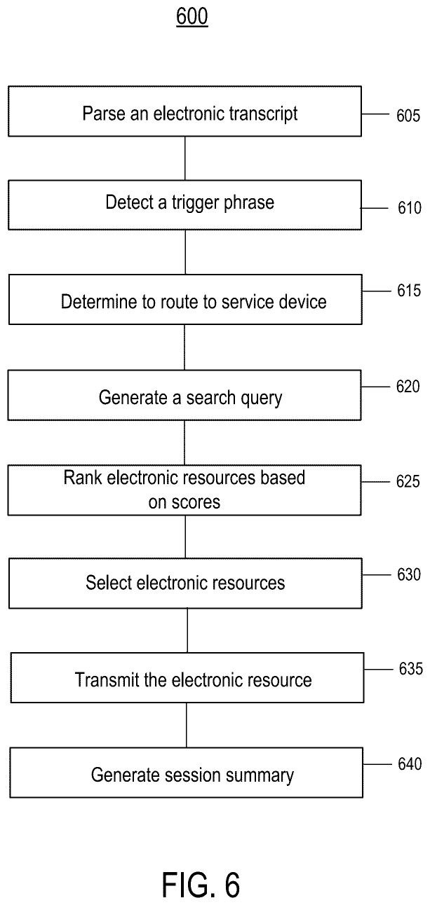

FIG. 6 shows an example process flow of a method 600 for detection of client performance issues and selection of relevant content materials for resolving the issue, based on a ML-based analysis of a transcript of an ongoing communication session between the client and a service provider. Method 600 can be implemented using the system tools, devices, and components discussed herein (e.g., system examples 100-200), for example, in connection with FIGS. 1-2. Method 600 can include acts 605-640. At 605, an electronic transcript can be parsed. At act 610, a trigger phrase can be detected. At act 615, a determination can be made to route the communication session to a service device. At act 620, a search query can be generated. At act 625, electronic resources can be ranked based on scores. At 630, one or more electronic resources can be selected. At act 635, the selected electronic resources can be transmitted. At 640, a summary of the communication session can be generated.

At 605, a transcript can be identified and parsed. The method can include parsing by one or more processors coupled with memory, an electronic transcript. The electronic transcript can be generated by a natural language processor using audio samples of a communication session established between a client device and a service device. The communication session can include a voice call (e.g., a VOIP or a telephone discussion), a video conference, a chat discussion, or any other telecommunications discussion between a client device and an agent device of a service provider.

The transcript can be parsed to identify at least a portion of the electronic transcript. The method can include identifying a transcript updated according to an ongoing call between a client and a provider of a service. For example, a data processing system can utilize a transcript function to generate, in real-time, a transcript of the ongoing call between a client and an agent of the enterprise at which the data processing system is deployed. The transcript can be continuously updated with portions of the transcript added in order to reflect the ongoing communication as it occurs. The transcript or the transcript portions can be input into one or more ML models (e.g., NLP or LLM models) trained using documents involving various different trigger phrases or phrases corresponding to specific performance events or issues experienced by clients on a variety of services or products. Based on the transcript or the transcript portions input into the one or more ML models, the ML models can search for various trigger phrases in the transcript.

At act 610, a trigger phrase can be detected. The method can include detecting, by the one or more processors, a trigger phrase. The trigger phrase can be detected prior to termination of the communication session and via input of the at least the portion of the electronic transcript into a first model trained with machine learning on historical log data. For example, the system can detect the trigger phrase before the audio call or phone call ends, or while the communication session between the client device and service device is still ongoing. By detecting the trigger phrase while the communication session is still ongoing, and before the communication session ends, the technical solutions described herein can reduce delay or latency associated with identifying and, thus, address the performance issue related to a software application, thereby improving the functioning or up-time of the software application.

The trigger phrase can include a phrase (e.g., one or more words or phrases) indicative of one or more performance issue events (e.g., performance issues) corresponding to, or indicative of, specific errors, issues, or challenges experienced by the client device in connection with one or more services or products provided by a service provider. The trigger phrase can map to a performance event concerning an application, such as an application provided by a service provider and used by the client (e.g., an application executed on a client device, a software as a service provided to the client via a cloud, or a web application provided by the service provider and accessed by the client).

The method can include detecting a processing event (e.g., an issue of the application) discussed by the client in the portion of the transcript. The processing event can be detected based at least on a portion of the transcript corresponding to a completed portion of the ongoing call input into a first ML model trained using data comprising a plurality of performance events (e.g., issues). The processing event can be detected based on a detected trigger phrase being used by one or more ML models trained using data on queries generated from trigger phrases to generate a query for a search engine to identify one or more resource documents identifying the performance issue event. For example, an issue detector of a data processing system can utilize an ML model (e.g., an NLP or LLM model) to detect or identify, from the transcript, one or more trigger phrases corresponding to the description of the issue provided in the transcript. The one or more trigger phrases can be identified using one or more ML models performing a semantic similarity search between the description of the performance event from the transcript and one or more descriptions of the same technical issue from the technical documents (e.g., electronic resources used for training the one or more ML models). The trigger phrases can be used as inputs into one or more ML models trained to generate the query based on the trigger phrases. The query can be used as an input into a search engine by the content selector to identify one or more electronic resources (e.g., technical documents) describing the performance issue event and the resolution of the technical issue. The one or more ML models can identify the electronic resources based on a similarity function between the embedding or vector of the query generated based on the trigger phrases and the vector representations of the electronic resources. Most closely matching electronic resources (e.g., documents) can be identified as the documents having information about the performance event, such as the issue, topic, question, or a problem that the client is having with the performance of the application. The issue, topic, question, or problem can concern a service or a product, such as a product, a software functionality, a service provided by the enterprise to the client, or any other product or service.

At act 615, a determination can be made to route the communication session (e.g., the service call) to a service device. The one or more processors can be configured to determine to route a call of the communication session to a particular service device based on trigger phrase. The trigger phrase can indicate, correspond to or be associated with a particular product, service, enterprise, technology or field. For instance, the one or more processors can execute the client communication function selecting or routing the communication sessions to determine, based on the type of the trigger phrase, or the content of the trigger phrase, to route the communication session (e.g., the service call) to a second service device. The second service device can be a device or a service configured for a particular type of service, enterprise, technology or product corresponding to, or indicative of, by the type or the content of the trigger phase. The one or more processors can determine to route the service call to a second service device (e.g., configured for a technology, service or product corresponding to, or indicated by, the trigger phrase) that is different than the initial service device to which the service call was routed or assigned. The one or more processors can trigger, based at least on the determination to route the call, the routing of the call to a particular service device, such the second service device.

The communication session (e.g., the service call) can be determined to be routed by the service device, such as when the service device operates, triggers or API calls the client communication function. The service device can determine to route the communication session in response to parsing of the electronic transcript at 605 or in response the contents of the trigger phrase detected at 610. For instance, responsive to parsing of an electronic transcript at 605, the service device can determine the context or language indicative of a particular enterprise, service, product, technology or field. Based on such a determination, the service device can determine to route the communication session to the service device configured for, or associated with, the agents for the given enterprise, service, product, technology or field. For instance, in response to detecting the trigger phrase at 610, the service device operating functions of the data processing system can determine to route the communication session to a different service device that can be configured for, or associated with, the enterprise, service, product, technology or field indicated by the trigger phrase.

At act 620, a query, such as a search query, can be generated. The method can include generating, by the one or more processors, responsive to input of the trigger phrase into a second ML model, a search query configured for input into a search engine. The second ML model can be an ML model trained with a transformer-based neural network on data corresponding to the performance events of the application. For instance, the method can include generating, by the at least one processor, a search query corresponding to the performance event described by the client during the portion of the ongoing communication session. The search query can be generated responsive to the detection of the trigger phrase and based at least on the trigger phrase, or data generated based on the trigger phrase, input into a second ML model.

The second ML model can be trained using data corresponding to performance events or issues of the application or the service provided to the client. For example, a query generator of the data processing system can utilize an ML model (e.g., NLP or LLM) to generate, produce, create, or provide a query defining, describing, indicating, or corresponding to the issue, topic, problem, or question of the client with respect to a performance issue associated with the application. The search query can, for example, accurately articulate or define the client concern, based on the transcript portions in which the client describes the issue or reasons for the call, such as a description of the technical issue experienced. This description can be used to generate the trigger phrase describing the technical issue or challenge faced by the client based on the technical documentation, which can then be used (e.g., the trigger phrase) as a basis from which the query can be generated. For instance, the search query can be utilized to generate the trigger phrase of act 610, based on which determination to route to a particular service device (e.g., based on the trigger phrase) can be determined at act 615.

At 625, the electronic resources can be scored and ranked. For instance, using the search query, the one or more processors can assign scores to the electronic resources. For instance, the search query can be represented as one or more tokens or embeddings (e.g., a vector representation) that can be generated based on the text of the search query. The vector or embedding of the search query can be then compared with various vector representations of a plurality of entries in the search engine to find or identify one or more similar or matching entries. For example, an ML model can be utilized to perform a similarity search, such as a cosine similarity or a Euclidean distance comparison, can be compared with the vector of the search query and the vectors or embeddings of various electronic resources. The results of such similarity search computations can be used to generate scores, which can be scores indicative of a similarity or contextual relationship between each given electronic resource (e.g., document in the database) and the search query.

Each of the electronic resources can be assigned the score based on their similarity search output. For instance, in a cosine similarity scenario, a document having a cosine similarity determination with respect to the search query of 0.995 can have a higher score than a document having a cosine similarity determination with respect to the same search query of 0.80. For instance, in a Euclidean distance scenario, a document having a Euclidean distance with respect to the search query of 0.995 can have a lower score than a document having a Euclidean distance with respect to the same search query of 0.01. The scores can be assigned to each of the documents, based on the similarity search results.

The electronic resources can be ranked based on their scores. For instance, the one or more processors can rank each of the documents from highest score to the lowest score as a result of the search. The documents having the highest score can be identified as the selected electronic resources to present for display to the service device (e.g., via the service application) to inform the agent handling the service call with the client of the documents or information from the documents that are useful or relevant to the ongoing communication session. At act 630, one or more electronic resource can be selected. The one or more processors can select the one or more electronic resources (e.g., documents having the relevant information to the issue identified by the trigger phrase in the ongoing communication session) based on the ranking of the electronic resources at 625. For instance, the one or more processors can select a set number of electronic resources based on their ranking at 625, such as top 3 highest ranked electronic resources. For example, the method can include selecting, by the one or more processors, via the search engine an electronic resource responsive to the search query generated via the second model. The electronic resource can include a document (e.g., an article, a data sheet, a specification, a procedure, a white paper, a research paper, a publication, a memorandum, or any other document) pertaining to a performance event or issue experienced by the client using the application.

The method can include selecting, by the at least one processor, based at least on the query input into a third model trained using data comprising a plurality of documents corresponding to the service, one or more documents within the field, and corresponding to the issue. For instance, the content selector can select by inputting the query (e.g., generated from the one or more trigger phrases) into a search engine of electronic resources, one or more content resources that were identified as most similar (e.g., having similarity function scores that are ranked and at the top of the list) to the query. The content resources can include documents discussing the performance issue event discussed in the transcript. For example, a content selector of the data processing system can use an ML model (e.g., NLP or LLM) to select from any number of content documents (e.g., articles, data sheets, product materials, specifications, procedures, service descriptions or white papers), one or more documents of particular relevance to the query or to the problem, issue, topic or question of the client.

At act 635, the electronic resource can be transmitted. The method can include the one or more processors transmitting the one or more selected electronic resources for receipt by the service device. The method can include transmitting, by the one or more processors, for rendering by the service device prior to termination of the communication session with the client device, the electronic resource. Rendering the electronic resource can refer to or include presenting the electronic resource for display via a graphical user interface on a display device. In some cases, rendering can include an audio output or haptic output in addition to, or instead of, a visual output. The method can include providing, via a graphical user interface of client communication function, one or more portions of the one or more electronic resources selected at act 620, to the client device. One or more ML models can summarize or paraphrase one or more sections of the selected electronic resources (e.g., responsive to the search query or the trigger phrase) and provide such a summary as a response to the client's question or the issue raised during the call. The method can include displaying the one or more documents via a user interface of an application executed on a service device. The method can include providing, by the at least one processor, for display to the provider, the one or more documents. For example, a user interface of the application can display for an agent of the enterprise communicating with the client over the call, an answer to the user's question, which can be generated from the one or more documents selected. For example, a data processing system can execute an application having a user interface, via which the application can display for the agent of the enterprise, the list of the one or more documents relevant to the client's question. The user interface can display an answer or a summary of the answer to the client's question, issue, topic, or problem.

At 640, the method can include generating a summary for the communication session. For example, the one or more processors can utilize one or more ML models trained to generate a summary of the communication session based on the audio samples or the transcript of the service call, to generate a summary of the communication session. The summary of the communication session can include identification of the technical issue discussed and addressed by the agent during the call, the trigger phrase and the electronic resources utilized. For instance, the one or more processors can input into one or more ML models at least a portion of the transcript of the call, a trigger phrase and identifications or references of the electronic resources selected during the service call and generate a single paragraph summary of the technical issue discussed and how the identified solution for the issue. The summary can identify whether the service call was successfully resolved and whether the information (e.g., electronic resources) generated by the data processing system successfully addressed the issue.

The foregoing examples have been provided merely for the purpose of explanation and are in no way to be construed as limiting the present disclosure. While aspects of the technical solutions have been described with reference to an exemplary embodiment, it is understood that the words that have been used herein are words of description and illustration, rather than words of limitation. Changes may be made, within the purview of the appended claims, as presently stated and as amended, without departing from the scope and spirit of the present disclosure in its aspects. Although aspects of the technical solutions have been described herein with reference to particular means, materials, and embodiments, the present disclosure is not intended to be limited to the particulars disclosed herein; rather, the present disclosure extends to all functionally equivalent structures, methods and uses, such as are within the scope of the appended claims.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements can include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses.

Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computer device”, “component” or “data processing system” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, a computer system 200 described in FIG. 2 can be used in conjunction with, instead of, or together with system 100 or its system components, and vice versa. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a computing system comprising one or more processors, coupled with memory, to:
parse an electronic transcript generated via a natural language processor from audio samples of a communication session established between a client device and a service device to identify at least a portion of the electronic transcript;
detect, prior to termination of the communication session and via input of the at least the portion of the electronic transcript into a first model trained with machine learning on historical log data, a trigger phrase that maps to a performance event concerning an application;
generate, responsive to input of the trigger phrase into a second model trained with a transformer-based neural network on data corresponding to performance events of the application, a search query configured for input into a search engine;
select, via the search engine, an electronic resource responsive to the search query generated via the second model; and
transmit, for receipt by the service device prior to termination of the communication session with the client device, the electronic resource or an identification of the electronic resource.

2. The system of claim 1, wherein the communication session corresponds to a voice call ongoing between the client device and the service device and wherein the application is provided by the computing system.

3. The system of claim 1, wherein the trigger phrase corresponds to a statement of a client communicating via the client device to identify an issue corresponding to the performance event of the application provided by a service provider associated with the service device.

4. The system of claim 1, wherein the one or more processors are further configured to:
select, based at least on the search query input into the search engine, one or more documents corresponding to the performance event;
generate a ranking for each of the one or more documents according to a similarity search between the search query and each of the one or more documents; and
provide, for display by the service device, the one or more documents ordered according to the ranking.

5. The system of claim 1, wherein the one or more processors are further configured to:
detect, prior to termination of the communication session and via input of the at least a second portion of the electronic transcript into the first model, a second trigger phrase that maps to a second performance event concerning the application;
generate, responsive to input of the second trigger phrase into the second model, a second search query configured for input into the search engine;
select, via the search engine, a second electronic resource responsive to the second search query generated via the second model; and
render, by the service device prior to termination of the communication session with the client device, the second electronic resource.

6. The system of claim 1, wherein the one or more processors are further configured to:
detect that the communication session has ended;
generate, responsive to the detection that the communication session has ended and based on the search query and the electronic resource and using a large language model, a summary of the communication session indicative of the performance event and a solution recommended according to the electronic resource; and
provide, for display via a user interface of the service device, the summary.

7. The system of claim 1, wherein the one or more processors are further configured to:
select, via the search engine, a plurality of electronic resources comprising the electronic resource;
generate, for the plurality of electronic resources, one or more scores, each of the one or more scores generated according to a relation between each of the plurality of electronic resources and the search query; and
provide, based at least on the one or more scores, a recommendation for the electronic resource of the plurality of electronic resources.

8. The system of claim 1, wherein the one or more processors are further configured to:
determine, based on the trigger phrase, to route a call of the communication session to a second service device; and
trigger, based at least on the determination to route the call, the routing of the call to the second service device.

9. A method, comprising:
parsing, by one or more processors coupled with memory, an electronic transcript generated via a natural language processor from audio samples of a communication session established between a client device and a service device to identify at least a portion of the electronic transcript;
detecting, by the one or more processors, prior to termination of the communication session and via input of the at least the portion of the electronic transcript into a first model trained with machine learning on historical log data, a trigger phrase that maps to a performance event concerning an application;
generating, by the one or more processors, responsive to input of the trigger phrase into a second model trained with a transformer-based neural network on data corresponding to performance events of the application, a search query configured for input into a search engine;
selecting, by the one or more processors, via the search engine, an electronic resource responsive to the search query generated via the second model; and
transmitting, by the one or more processors, for receipt by the service device prior to termination of the communication session with the client device, the electronic resource.

10. The method of claim 9, wherein the communication session corresponds to a voice call ongoing between the client device and the service device and wherein the application is provided by the one or more processors.

11. The method of claim 9, wherein the trigger phrase corresponds to a statement of a client communicating via the client device to identify an issue corresponding to the performance event of the application provided by a service provider associated with the service device.

12. The method of claim 9, comprising:
selecting, by the one or more processors, based at least on the search query input into the search engine, one or more documents corresponding to the performance event;
generating, by the one or more processors, a ranking for each of the one or more documents according to a similarity search between the search query and each of the one or more documents; and
providing, by the one or more processors, for display by the service device, the one or more documents ordered according to the ranking.

13. The method of claim 9, comprising:
detecting, by the one or more processors, prior to termination of the communication session and via input of the at least a second portion of the electronic transcript into the first model, a second trigger phrase that maps to a second performance event concerning the application;
generating, by the one or more processors, responsive to input of the second trigger phrase into the second model, a second search query configured for input into the search engine;
selecting, by the one or more processors, via the search engine, a second electronic resource responsive to the second search query generated via the second model; and
rendering, by the one or more processors, by the service device prior to termination of the communication session with the client device, the second electronic resource.

14. The method of claim 9, comprising:
detecting, by the one or more processors, that the communication session has ended;
generating, by the one or more processors, responsive to the detection that the communication session has ended and based on the search query and the electronic resource and using a large language model, a summary of the communication session indicative of the performance event and a solution recommended according to the electronic resource; and
providing, by the one or more processors, for display via a user interface of the service device, the summary.

15. The method of claim 9, comprising:
selecting, by the one or more processors, via the search engine, a plurality of electronic resources comprising the electronic resource;
generating, by the one or more processors, for the plurality of electronic resources, one or more scores, each of the one or more scores generated according to a relation between each of the plurality of electronic resources and the search query; and
providing, by the one or more processors, based at least on the one or more scores, a recommendation for the electronic resource of the plurality of electronic resources.

16. The method of claim 9, comprising:
determining, by the one or more processors, based on the trigger phrase, to route a call of the communication session to a second service device; and
triggering, by the one or more processors, based at least on the determination to route the call, the routing of the call to the second service device.

17. A non-transitory computer-readable medium storing instructions that, when executed by at least one processor, cause the at least one processor to:
parse an electronic transcript generated via a natural language processor from audio samples of a communication session established between a client device and a service device to identify at least a portion of the electronic transcript;
detect, prior to termination of the communication session and via input of the at least the portion of the electronic transcript into a first model trained with machine learning on historical log data, a trigger phrase that maps to a performance event concerning an application;
generate, responsive to input of the trigger phrase into a second model trained with a transformer-based neural network on data corresponding to performance events of the application, a search query configured for input into a search engine;
select, via the search engine, an electronic resource responsive to the search query generated via the second model; and
transmit, for render by the service device prior to termination of the communication session with the client device, the electronic resource.

18. The non-transitory computer-readable medium of claim 17, wherein the communication session corresponds to a voice call ongoing between the client device and the service device and wherein the application is provided by the at least one processor.

19. The non-transitory computer-readable medium of claim 17, wherein the trigger phrase corresponds to a statement of a client communicating via the client device to identify an issue corresponding to the performance event of the application provided by a service provider associated with the service device.

20. The non-transitory computer-readable medium of claim 17, wherein the instructions, when executed by the at least one processor, cause the at least one processor to:
select, based at least on the search query input into the search engine, one or more documents corresponding to the performance event;
generate a ranking for each of the one or more documents according to a similarity search between the search query and each of the one or more documents; and
provide, for display by the service device, the one or more documents ordered according to the ranking.
